(19) United States
(12) Patent Application Publication
(10) Pub. No.: US 2012/0044389 A1
(43) Pub. Date: Feb. 23, 2012

(54) METHOD FOR GENERATING SUPER RESOLUTION IMAGE

(75) Inventors: Yun Chin Li, Taipei County (TW); Chan Min Chou, Taipei County (TW)

(73) Assignee: ALTEK CORPORATION, Hsinchu (TW)

(21) Appl. No.: 12/860,266

(22) Filed: Aug. 20, 2010

(51) Int. Cl. H04N 5/217

(52) U.S. Cl. 348/241; 348/E05.078

(57) ABSTRACT

A method generates a super resolution (SR) image by the steps of receiving a plurality of images corresponding to the same shot target; selecting one of the images as a basic image, and using the images except the basic image as a plurality of reference images; processing the reference images by using a geometric coordinate correction procedure according to the basic image, so as to generate a plurality of corrected images respectively corresponding to the reference images; and performing a resolution enhancement procedure on the basic image and the corrected images, so as to generate the SR image.

### BACKGROUND OF THE INVENTION

1. Field of the Invention

The present invention relates to a method for generating a super resolution (SR) image, and more particularly to a method for generating an SR image having low resource requirements.

2. Related Art

Digital cameras have become very popular at present, and are provided with more functions with the development of technologies. Besides a photo mode of the conventional photographing function, digital cameras have been developed to have a movie mode for recording a video. However, since the resources of the digital camera are limited, frames (also referred to as image frames) captured in the movie mode have a rather low resolution. For example, in order to obtain continuous video pictures, an ordinary digital camera or video camera in the movie mode needs to capture at least 30 to 60 images per second. That is to say, the digital camera must process at least 30 to 60 images per second. Both the processing speed and buffer capacity of a micro processor unit of the digital camera are limited, so the image resolution must be lowered to process more images in unit time.

Although a user can use the same digital camera for taking photos or recording a video, he/she cannot capture high resolution (HR) images during video recording. The user has to stop video recording and switch the digital camera back to the photo mode in order to capture HR images. However, the switching between the photo mode and the movie mode consumes a period of time, so the user may miss the opportunity to capture desired pictures. To enable the user to obtain a desired still image during video recording without mode switching, two methods may be considered.

The first method is to use a high-speed sensor to capture all video frames, and then use a high-speed processor for subsequent processing. Very few digital cameras for special applications can directly perform HR video recording, which firstly process HR frames and then convert the frames into a low resolution video according to practical requirements, so that an HR still image can be obtained from the originally captured continuous frames. However, such digital cameras need to use a high-level sensor and a high-speed computing processor, which require a high cost of parts and high power consumption, and thus are not suitable for use by ordinary consumers. In addition, for a dark scene, this method easily causes generation of output image with high noise.

The second method is to separately compress one frame in a video into a still image and provide the image to the user. Based on the consideration of the cost and power consumption, sensors used by consumer digital cameras cannot output an HR image in real-time. In addition, considering the duration of video recording and cost, it will not process an HR image in advance and then convert the HR image into a low resolution image for storage. Therefore, in the movie mode, low resolution frames are directly obtained by a sensor first, and then a high-speed image sequence (that is, video) is output. When a still image needs to be output, a particular frame is directly acquired from the low resolution video recording sequence and then output. However, since the image resolution in the movie mode is not high, the resolution of the output still image is far lower than that obtained in the photo mode.

That is, the conventional methods for obtaining a desired still image during video recording without mode switching have the problems of high cost and resource requirements, low resolution of the obtained still image, and even high-noise of the obtained still image. A heretofore unaddressed need exists in the art to address the aforementioned deficiencies and inadequacies.

### SUMMARY OF THE INVENTION

Accordingly, the present invention is a method for generating a super resolution (SR) image, which is applicable to a digital camera. The method for generating the SR image comprises: receiving a plurality of images corresponding to the same shot target; selecting one of the images as a basic image, and using the images except the basic image as a plurality of reference images; processing the reference images by using a geometric coordinate correction procedure according to the basic image, so as to generate a plurality of corrected images respectively corresponding to the reference images; and performing a resolution enhancement procedure on the basic image and the corrected images, so as to generate the SR image.

The method for generating the SR image is performed by a micro processor unit of the digital camera. Preferably, the geometric coordinate correction procedure may be performed only once, so as to reduce the resource requirements when the SR image is generated.

According to an embodiment of the present invention, after the step of processing the reference images by using a geometric coordinate correction procedure according to the basic image, so as to generate a plurality of corrected images respectively corresponding to the reference images, the method for generating the SR image further comprises: performing a denoising procedure on the basic image and the corrected images. The denoising procedure may comprise: processing the basic image and the corrected images by using a median filter.

The step of performing a resolution enhancement procedure on the basic image and the corrected images, so as to generate the SR image comprises: performing the resolution enhancement procedure on the basic image and the corrected images, and generating a high resolution (HR) image; calculating an error value of the HR image; determining whether the error value is smaller than a threshold; and when the error value is smaller than the threshold, using the HR image as the SR image.

The step of performing a resolution enhancement procedure on the basic image and the corrected images, so as to generate the SR image may further comprise: when the error value is greater than or equal to the threshold, returning to the step of performing the resolution enhancement procedure on the basic image and the corrected images, and generating a HR image, so as to regenerate the HR image.

The resolution enhancement procedure may comprise: processing the basic image and the corrected images by using an iterative back projection (IBP) method. The resolution enhancement procedure may further comprise: processing a local part of the basic image and the corrected images by using a motion estimation method.

According to an embodiment of the present invention, on a time axis, the basic image is closest to a center of the images. In addition, the images are received and the SR image is generated in an on-line mode or an off-line mode.

Based on the above, the method for generating the SR image generates a clear and high-resolution SR image according to the images in a video. In addition, since the geometric coordinate correction procedure is performed only once, the resource requirements of the method for generating the SR image is low, and no high-level micro processor unit is required. Therefore, the cost of the digital camera to which the method for generating the SR image is applicable is far lower than that of a conventional camera that uses a high-level sensor and processor to generate an HR image.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a block diagram of a digital camera according to an embodiment of the present invention;

FIG. 2 is a flow chart of a method for generating a super resolution (SR) image according to an embodiment of the present invention;

FIG. 3 is a schematic view of a basic image and a reference image according to an embodiment of the present invention;

FIG. 4 is a schematic view of a basic image and a corrected image according to an embodiment of the present invention;

FIG. 5 is a flow chart of Step S130 according to an embodiment of the present invention; and

FIG. 6 is a flow chart of a method for generating an SR image according to another embodiment of the present invention.

### DETAILED DESCRIPTION OF THE INVENTION

The detailed features and advantages of the present invention are described below in detail through the following embodiments, the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

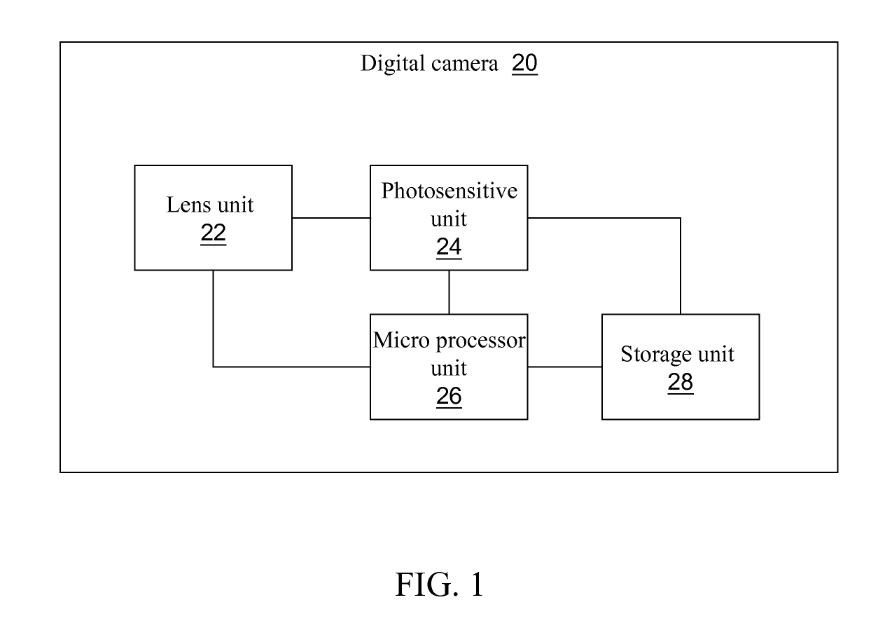

The present invention is a method for generating a super resolution (SR) image, applicable to a digital camera. The method for generating the SR image generates a high-resolution and clear SR image according to a plurality of low-resolution images. FIG. 1 is a block diagram of a digital camera according to an embodiment of the present invention.

A digital camera 20 may comprise a lens unit 22, a photosensitive unit 24, a micro processor unit 26 and a storage unit 28. When capturing an image, the digital camera 20 focuses the lens unit 22 at a focusing distance. The micro processor unit 26 controls the lens unit 22 to a focusing position corresponding to the focusing distance, and stores images obtained by the lens unit 22 and the photosensitive unit 24 into the storage unit 28.

The method for generating the SR image is performed by the micro processor unit 26.

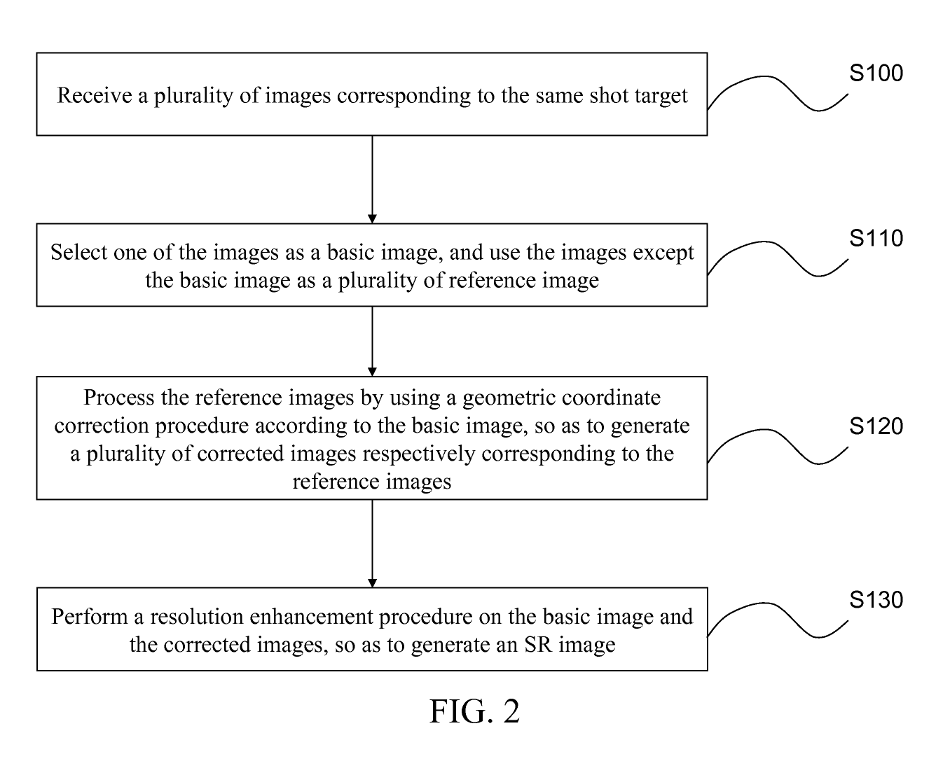

FIG. 2 is a flow chart of a method for generating a super resolution (SR) image according to an embodiment of the present invention. Firstly, images corresponding to the same shot target (or scene) are received through the lens unit 22 and the photosensitive unit 24 (Step S100). In detail, the images may be captured by the digital camera 20 in a movie mode for a certain shot target, and are a part of continuous frames (also referred to as image frames) of the captured video.

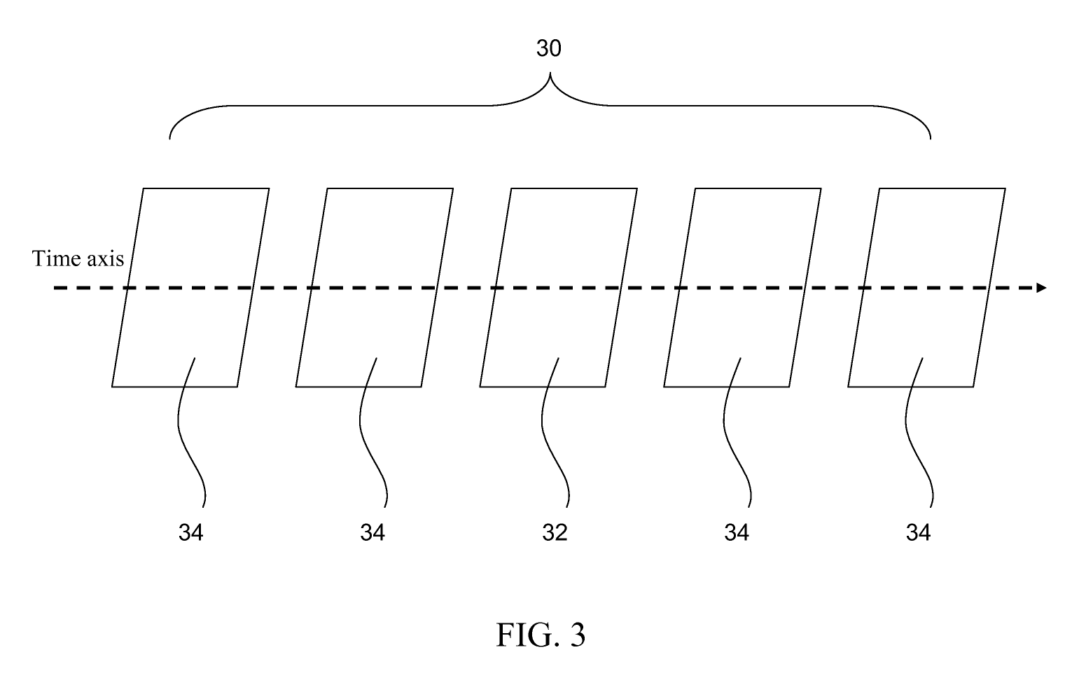

After receiving the images, the micro processor unit 26 selects one of the images as a basic image, and uses the images except the basic image as a plurality of reference images (Step S110). FIG. 3 is a schematic view of a basic image and a reference image according to an embodiment of the present invention. According to an embodiment of the present invention, on a time axis, the basic image 32 is closest to a center of the images 30. In other words, when the images 30 are arranged on the time axis according to the order of acquisition, the image 30 closest to the center of the images 30 is selected as the basic image 32. However, according to another embodiment of the present invention, the basic image 32 may also be the first image 30 or the last image 30 among the images 30. The method for generating the SR image does not limit the method for selecting the basic image 32.

Each image 30 has respective pixel coordinates. Although the images 30 are corresponding to the same shot target, the images 30 may have different pixel coordinates if the shooting angle is changed or the shot target moves when the images are captured. For example, when a video is recorded for a walking person, the shot person may be present at different positions in each frame of the video. That is to say, some tiny differences exist between the images 30. The method for generating the SR image is just to integrate the tiny differences into an HR image, so as to enhance the resolution of the output image.

To correctly integrate the tiny differences between the images 30, the reference images 34 are processed by using a geometric coordinate correction procedure according to the basic image 32, so as to generate a plurality of corrected images respectively corresponding to the reference images 34 (Step S120). The geometric coordinate correction procedure may firstly find a plurality of feature points in the basic image 32 and the reference images 34 by using various digital image processing (DIP) techniques, and calculate pixel coordinates of the feature points. According to the feature points, image segmentation may be further performed on the images 30, so as to obtain the constitution of pictures of the images 30. According to the coordinates of sufficient feature points, the geometric coordinate correction procedure can generate a plurality of conversion matrixes respectively corresponding to the reference images 34 based on the basic image 32, and then modify the pixel coordinates of the reference images 34 by using the conversion matrixes to obtain the corrected images.

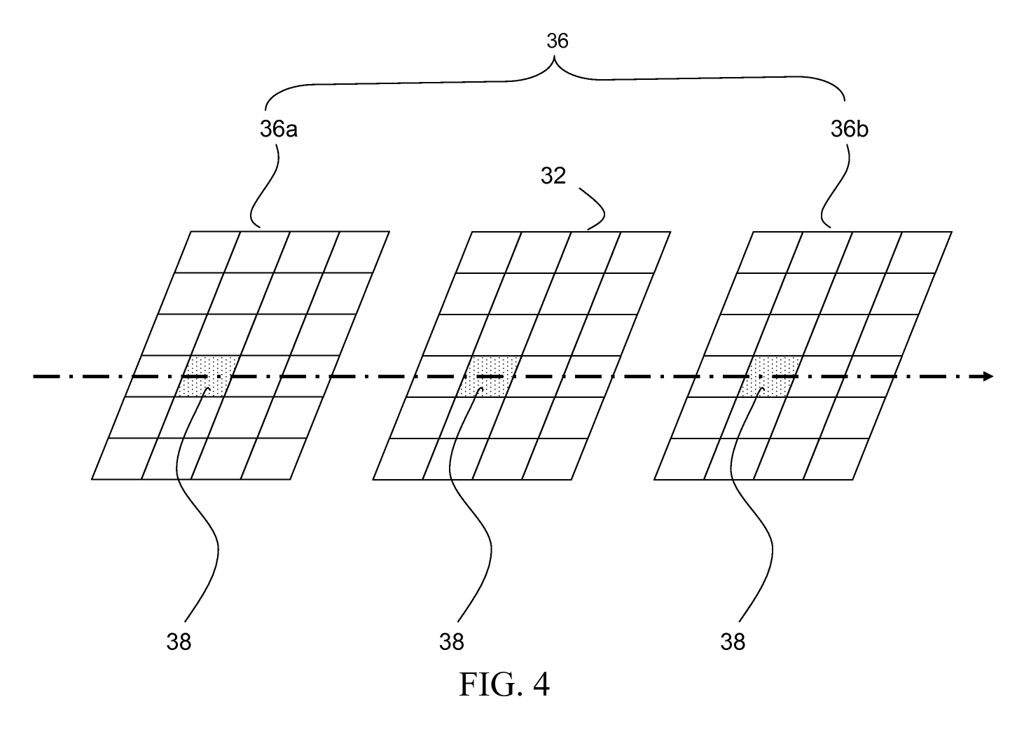

FIG. 4 is a schematic view of a basic image and a corrected image according to an embodiment of the present invention. The same shot object (for example, a tip of a person's hair or a leaf on a tree) has the same pixel coordinates in the basic image 32 or the corrected images 36. In other words, target pixels 38 in the basic image 32, the corrected image 36a and the corrected image 36b are corresponding to the same shot object.

Since the coordinate correction procedure uses a variety of DIP techniques and a large number of matrix operations, considerable resources of the micro processor unit 26 may be consumed. Preferably, Step S120 and the geometric coordinate correction procedure are performed only once, so as to reduce the resource requirements when the SR image is generated.

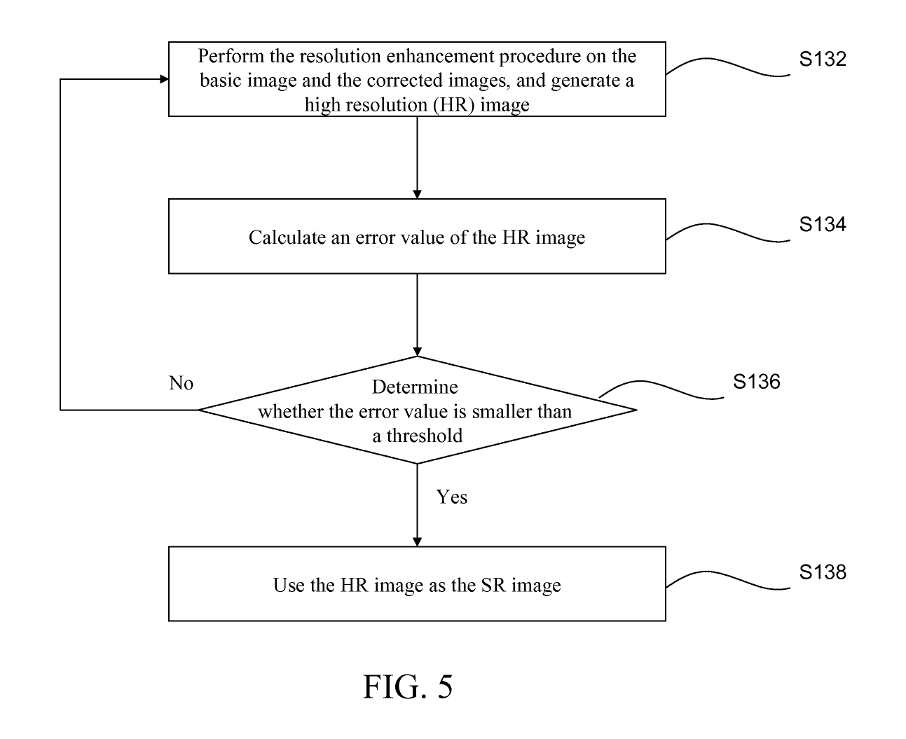

After obtaining the corrected images 36 by correcting the reference images 34 according to the basic image 32, the micro processor unit 26 performs a resolution enhancement procedure on the basic image 32 and the corrected images 36, so as to generate an SR image (Step 130). FIG. 5 is a flow chart of Step S130 according to an embodiment of the present invention.

The micro processor unit 26 firstly performs the resolution enhancement procedure on the basic image 32 and the corrected images 36, and generates an high resolution (HR) image P (Step S132).

The resolution enhancement procedure may comprise: processing the basic image 32 and the corrected images 36 by using an iterative back projection (IBP) method. The IBP method is to perform iterative back projection by repeatedly simulating low resolution images and observing differences between the low resolution images so as to obtain the HR image P. Firstly, the basic image 32 is directly enlarged to a target high resolution, which is then used as the HR image P through ordinary simple image interpolation. Then, the HR image P is reduced to the same resolution as the basic image 32 and the corrected images 36 to serve as an foundation image LP. The micro processor unit 26 respectively calculates differences between the foundation image LP obtained by reduction and the basic image 32/the corrected images 36, and then feeds back and integrates the differences into the HR image P.

If the digital camera 20 has sufficient operation resources, the resolution enhancement procedure may further comprise: processing a local part of the basic image 32 and the corrected images 36 by using a motion estimation method, so as to obtain the HR image P with clearer details.

Then, the micro processor unit 26 calculates an error value of the HR image P (Step S134), and determines whether the error value is smaller than a threshold (Step S136). The error value may be an average difference value between the foundation image LP and the corrected images 36 and the basic image 32. The difference value may be, for example, a difference of values of each pixel corresponding to the same pixel coordinates in the foundation image LP and the corrected images 36 and the basic image 32. If the error value is smaller than the threshold, it indicates that the HR image P has integrated various detailed image information in the basic image 32 and the corrected images 36, such that the HR image P is clear enough. Therefore, when the error value is smaller than the threshold, the HR image P is output as the SR image (Step S138).

On the contrary, if the error value is greater than or equal to the threshold, it indicates that the current HR image P is not clear enough. Therefore, Step S132 of performing the resolution enhancement procedure on the basic image 32 and the corrected images 36, and generating the HR image P is returned, so as to regenerate the HR image P. In other words, Step S132 may be repeated to continue to integrate the differences between the basic image 32 and the corrected images 36 into the HR image P, so as to enhance the resolution of the HR image P.

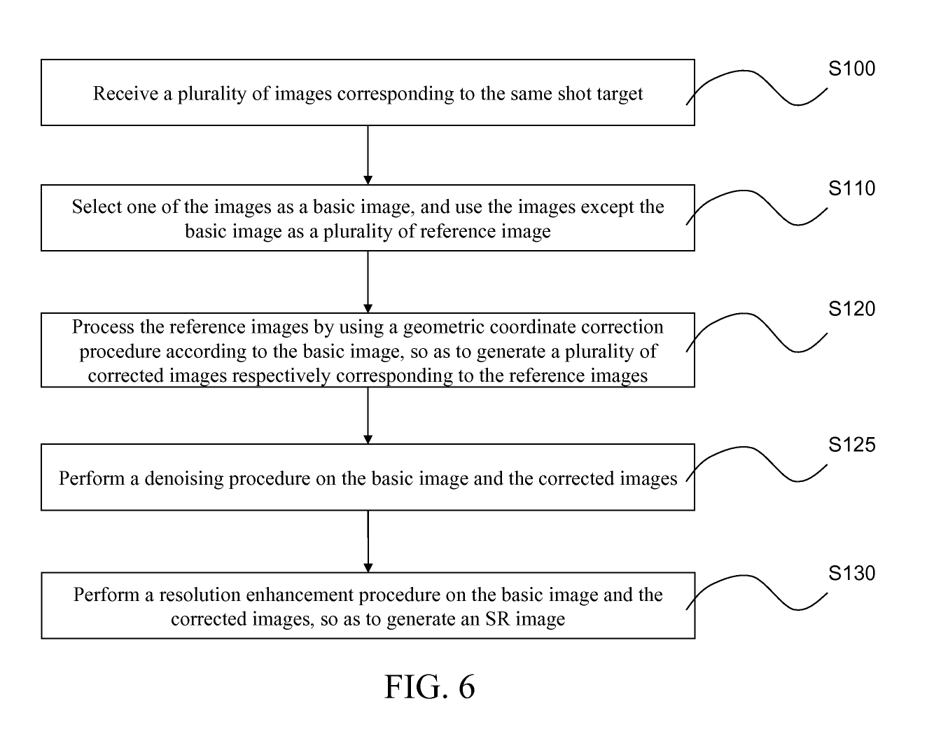

FIG. 6 is a flow chart of a method for generating an SR image according to another embodiment of the present invention. If the digital camera 20 still has sufficient operation resources, after the corrected images 36 are generated in Step S120, the method for generating the SR image may further comprise: performing a denoising procedure on the basic image 32 and the corrected images 36 (Step S125). The denoising procedure may comprise: processing the basic image 32 and the corrected images 36 by using a median filter. Besides the median filter, the denoising procedure may also use a low pass filter or other methods, which is not limited in the method for generating the SR image.

According to an embodiment of the present invention, the micro processor unit 26 receives the images 30 and generates the SR image in an on-line mode or an off-line mode. The on-line mode means that the digital camera 20 is in the movie mode. The micro processor unit 26 processes in real-time the video being recorded, and generates in real-time the SR image according to the images 30. In the off-line mode, the digital camera 20 has completed video recording or photo taking, and the micro processor unit 26 reads a part of frames in the video from the storage unit 28 as the images 30 for generating the SR image. Since in the off-line mode, the digital camera 20 does not need to allocate resources to acquire a video or photo, a large number of images 30 can be used to generate a higher-quality SR image.

Based on the above, the method for generating the SR image processes the video images by performing the geometric coordinate correction procedure for once, and repeatedly performing the resolution enhancement procedure, so as to obtain a clear and high-resolution SR image. Since the geometric coordinate correction procedure is performed only once, the method for generating the SR image requires low operation and buffer resources, and thus is applicable to an ordinary consumer digital camera. If the digital camera has sufficient resources, the method for generating the SR image can further enhance the quality of the SR image by using the denoising procedure, the motion estimation method or other techniques.

In addition, the conventional method that directly uses a video frame as an output causes a significant block effect due to compression; while even in the off-line mode, the method for generating the SR image can greatly reduce the block effect of the generated SR image.

What is claimed is:

1. A method for generating a super resolution (SR) image, applicable to a digital camera, the method for generating the SR image comprising:
receiving a plurality of images corresponding to the same shot target;
selecting one of the images as a basic image, and using the images except the basic image as a plurality of reference images;
processing the reference images by using a geometric coordinate correction procedure according to the basic image, so as to generate a plurality of corrected images respectively corresponding to the reference images; and
performing a resolution enhancement procedure on the basic image and the corrected images, so as to generate the SR image.

2. The method for generating the SR image according to claim 1, wherein the geometric coordinate correction procedure is performed only once.

3. The method for generating the SR image according to claim 1, wherein on a time axis, the basic image is closest to a center of the images.

4. The method for generating the SR image according to claim 1, wherein after the step of processing the reference images by using a geometric coordinate correction procedure according to the basic image, so as to generate a plurality of corrected images respectively corresponding to the reference images, the method for generating the SR image further comprises:
performing a denoising procedure on the basic image and the corrected images.

5. The method for generating the SR image according to claim 4, wherein the denoising procedure comprises:
processing the basic image and the corrected images by using a median filter.

6. The method for generating the SR image according to claim 1, wherein the step of performing a resolution enhancement procedure on the basic image and the corrected images, so as to generate the SR image comprises:
performing the resolution enhancement procedure on the basic image and the corrected images, and generating a high resolution (HR) image;
calculating an error value of the HR image;
determining whether the error value is smaller than a threshold; and
when the error value is smaller than the threshold, using the HR image as the SR image.

7. The method for generating the SR image according to claim 6, wherein the step of performing a resolution enhancement procedure on the basic image and the corrected images, so as to generate the SR image further comprises:
when the error value is greater than or equal to the threshold, returning to the step of performing the resolution enhancement procedure on the basic image and the corrected images, and generating the HR image, so as to regenerate the HR image.

8. The method for generating the SR image according to claim 1, wherein the images are received and the SR image is generated in an on-line mode or an off-line mode.

9. The method for generating the SR image according to claim 1, wherein the resolution enhancement procedure comprises:
processing the basic image and the corrected images by using an iterative back projection (IBP) method.

10. The method for generating the SR image according to claim 9, wherein the resolution enhancement procedure further comprises:
processing a local part of the basic image and the corrected images by using a motion estimation method.
